(19) United States
(12) Patent Application Publication
(10) Pub. No.: US 2013/0177682 A1
(43) Pub. Date: Jul. 11, 2013

(54) Compositions and Methods for Preserving Game Meat

(71) Applicant: Blayne St. James, Winsor, CO (US)

(72) Inventor: Blayne St. James, Winsor, CO (US)

(73) Assignee: ST. JAMES HUNTING PRODUCTS LLC, Winsor, CO (US)

(21) Appl. No.: 13/546,234

(22) Filed: Jul. 11, 2012

Related U.S. Application Data
(60) Provisional application No. 61/508,370, filed on Jul. 15, 2011.

(51) Int. Cl. A23B 4/12; C14C 9/00; A01N 37/04

(52) U.S. Cl. CPC A23B 4/12; A01N 37/04; C14C 9/00
USPC 426/332; 426/532; 222/92; 514/574; 8/94.15

(57) ABSTRACT

Provided herein are compositions and methods of using those compositions in treating game meat to prevent spoilage and/or contamination. Also provided are compositions and methods of using those compositions in acidifying the surface of game meat. Compositions provided herein can be used to prevent contamination and/or spoilage of meat. Likewise, compositions provided herein can be used to treat butchered meat to tenderize the meat and/or to prevent the growth of dormant bacteria on freshly thawed meat. Compositions provided herein can be used to prevent or mitigate hair loss from a hide or cape to preserve the quality of the leather.

### RELATED APPLICATIONS

This application claims priority under 35 U.S.C. 119 (e) to U.S. Provisional Patent Application Ser. No. 61/508,370, entitled “Compositions and Methods for Preserving Game Meat”, filed Jul. 15, 2011, the disclosure of which is hereby incorporated by reference in its entirety.

### FIELD

This disclosure relates to preservation of meat, and in particular, preservation of game meat against spoilage.

### BACKGROUND

The statements in this section merely provide background information related to the present disclosure and may not constitute prior art.

Meat spoilage is typically caused by unwanted growth of bacteria. When freshly obtained meat is treated with acid, the pH is generally sufficiently low such that growth of bacteria which are harmful to humans and/or animals is inhibited.

Citric acid is a weak organic acid and a natural preservative. In the field, citric acid is sprayed as a solution of 1 ounce of citric acid powder in 1 quart of water on fresh game meat to help prevent contamination by microorganisms or bacteria.

There are a number of businesses that sell commercial-grade citric acid powder for use as a game saver. However, despite its usefulness, citric acid is very corrosive and can cause severe burns to the skin, lungs, and eyes. This is important in the field where weather conditions vary, and in particular, where protection from the wind is typically nonexistent. Wind can cause the citric acid powder to disperse into the air while the user is trying to combine the citric acid with water to form the citric acid water solution.

Further effort is needed to find safer and more efficient ways of field treating game meat to prevent spoilage and/or contamination by insects.

The present invention is directed toward overcoming one or more of the problems discussed above.

### SUMMARY

Provided herein are compositions and methods of using those compositions in treating game meat to prevent spoilage and/or contamination by insects. Also provided are compositions and methods of using those compositions in acidifying the surface of game meat. Compositions provided herein can be used to prevent contamination and/or spoilage of meat. Likewise, compositions provided herein can be used to treat butchered meat to tenderize the meat and/or to prevent the growth of dormant bacteria on freshly thawed meat. Compositions provided herein can be used to prevent or mitigate hair loss from a hide or cape to preserve the quality of the leather. For purposes herein, the term “prevent” includes partial and/or complete prevention.

In some embodiments, the composition comprises: i) citric acid; and ii) one or more of sodium acid sulfate, tartaric acid, malic acid, carbonate, and magnesium stearate. In some embodiments, the composition comprises citric acid, sodium acid sulfate, tartaric acid, malic acid, carbonate, and magnesium stearate.

In some embodiments, the compositions herein are formulated in a capsule form. In other embodiments, the compositions herein are formulated in a tablet form.

Also provided is a game meat product comprising game meat having the composition applied to the surface, wherein the composition comprises: i) citric acid; and ii) one or more of sodium acid sulfate, tartaric acid, malic acid, carbonate, and magnesium stearate. In some aspects, the composition applied to the surface comprises citric acid, sodium acid sulfate, tartaric acid, malic acid, carbonate, and magnesium stearate.

Further provided are methods of preserving game meat. In one aspect, the method comprises contacting the surface of the game meat with a formulation comprising citric acid and one or more of sodium acid sulfate, tartaric acid, malic acid, carbonate, and magnesium stearate.

Also provided are methods for retarding microbial growth. In some aspects, the microbial growth is responsible for spoilage, e.g. mold or yeast. In some aspects, the microbial growth is harmful, e.g. E. coli, listeria, Salmonella, etc.

Still further provided herein are kits. In one embodiment, the kit comprises (i) one or more capsules for preparing a citric acid solution, wherein the capsules comprise citric acid, sodium acid sulfate, tartaric acid, malic acid, carbonate, and magnesium stearate; and (ii) instructions for using the citric acid solution. In some embodiments, the kit further comprises a collapsible bottle configured with a spray top.

Further areas of applicability of the present teachings will become apparent from the description provided herein. It should be understood that the description and specific examples are intended for purposes of illustration only and are not intended to limit the scope of the present teachings.

### DETAILED DESCRIPTION

The following description is merely exemplary in nature and is not intended to limit the present disclosure, application, claims, compositions, or uses.

Provided herein are compositions and methods of using those compositions in treating game meat to prevent spoilage and/or contamination by insects. Also provided are compositions and methods of using those compositions in acidifying the surface of game meat. Compositions provided herein can be used to prevent contamination and/or spoilage of meat. Likewise, compositions provided herein can be used to treat butchered meat to tenderize the meat and/or to prevent the growth of dormant bacteria on freshly thawed meat. Compositions provided herein can be used to prevent or mitigate hair loss from a hide or cape to preserve the quality of the leather. The citric acid solution retards the growth of bacteria which are instrumental in breakdown of the hides.

As used herein, the phrase “game meat” refers to meat obtained from game animals including but not limited to deer, elk, javelina, wild boar, bear, buffalo, pronghorn, antelope, wild sheep/goats, caribou, moose, cougar, alligator, fowl, and fish. It is also contemplated that the compositions provided herein can be useful in home butchering situations. As such, the compositions can be used on all types of freshly obtained meat including beef, pork, lamb, goat, chicken, etc.

Disclosed herein are certain formulations that can provide a safer, more convenient, source of citric acid than citric acid powders. Surprisingly, when combined with water, the citric acid formulation embodiments herein quickly dissolve into solution for easy application to the game meat. The formulations can be used even in windy conditions without concern that any of the corrosive powder will come into contact with the eyes, lungs, and skin. The formulations are convenient to use since no measuring of powder is required, and the packaged formulations are lightweight for easy transport in the field while hunting. Further, while in the field, use is accurate: no measuring is required nor is measuring inaccuracy a problem due to poor light or inclement weather. In some embodiments, the citric acid composition is formulated in a capsule. In some embodiments, the citric acid composition is formulated in a tablet. In some embodiments, the citric acid composition is formulated in a prepackaged disposable container—a specified amount of water is added to the container to create the citric acid solution for application to the game meat.

The food grade citric acid formulation is added to water until the resulting solution has a pH in the range of about 1 to about 6. In some embodiments, the resulting pH is less than about 5, less than about 4, less than about 3, or less than about 2. In some embodiments, the resulting citric acid solution has a pH of about 1.7 to about 3, for example, about 1.8, about 1.9, about 2.0, about 2.1, about 2.2, about 2.3, about 2.4, about 2.5, about 2.6, about 2.7, about 2.8, about 2.9, or about 3.0.

In one aspect, about 0.5 ounce of citric acid is added to 16 ounces of water to generate a citric acid solution with a pH of less than about 3, for example, about 2 or less than about 2. In another aspect, about 1 ounce of citric acid is added to 32 ounces of water to generate a citric acid solution with a pH of less than about 3, for example about 2 or less than about 2. Each amount of citric acid may be formulated into an individual capsule or tablet.

In another aspect, at least one of citric acid, tartaric acid, and malic acid are added to water to generate a solution with a pH of less than about 3, for example about 2 or less than about 2.

In yet another aspect, about 1300 milligrams to about 6000 milligrams of citric acid is added to 16 ounces of water to generate a citric acid solution with a pH of less than about 3, for example, about 2 or less than about 2. In another aspect, about 3000 milligrams to about 12,000 miligrams of citric acid is added to 32 ounces of water to generate a citric acid solution with a pH of less than about 3, for example about 2 or less than about 2.

In some aspects, the encapsulated e.g., hard, soft, etc., formulation comprises citric acid, SAS (sodium acid sulfate), tartaric acid, malic acid, sodium bicarbonate and/or sodium carbonate, and magnesium stearate. In other aspects, the encapsulated formulation comprises citric acid and one or more of SAS (sodium acid sulfate), tartaric acid, malic acid, sodium bicarbonate and/or sodium carbonate, and magnesium stearate.

In some aspects, the tableted e.g., compressed, molded, etc., formulation comprises citric acid, SAS (sodium acid sulfate), tartaric acid, malic acid, sodium bicarbonate and/or sodium carbonate, and magnesium stearate. In other aspects, the tableted formulation comprises citric acid and one or more of SAS (sodium acid sulfate), tartaric acid, malic acid, sodium bicarbonate and/or sodium carbonate, and magnesium stearate. Note that tablets herein include coated tablets having a protective coating for the formulation.

Illustratively, a formulation embodied herein consists essentially of citric acid, SAS, tartaric acid, malic acid, sodium bicarbonate and/or sodium carbonate, and magnesium stearate.

In some embodiments, it can be beneficial to avoid or minimize ingredients that create sediment in the formulation, that clog the sprayer, that make the tablet too sticky, that raise the pH above about 3.0 or above about 2.7, that discourage dissolution of the tablet or capsule, etc.

However, it is contemplated herein that certain ingredients can be used which will minimize or reduce the sediment of a given formulation. Exemplary ingredients include polyethylene glycol and other chemicals with similar properties.

Formulations provided herein can be modified based on the need for a more antimicrobial effect than an insect repellent or based on the need for more of an insect repellant than for antimicrobial effect. For example, a formulation comprising citric acid and tartaric acid can be useful as an insect repellent with secondary functionality as an antimicrobial. On the other hand, a formulation containing SAS can have a primary functionality as an antimicrobial.

Additives such as flavorings and spices can be used with the citric acid formulation or citric acid solution as long as the final pH remains within the specified range.

Likewise, lactic acid can be added to the formulation to enhance the preservative effect. The additives can be part of the tablet or capsule or can be added to the water independently from the citric acid formulation.

Exemplary spices and/or flavorings contemplated herein include but are not limited to pepper (black, red, and/or white), cinnamon, cayenne pepper and other hot peppers, curry (typically containing cumin, coriander, fenugreek, ginger, turmeric, dill seed, black pepper, red pepper, mace, cardamom, and cloves), oregano, paprika, turmeric, mace, cloves, mint, basil, mustard, allspice, bay leaf, caraway, coriander, cumin, rosemary, sage, thyme, garlic, onion, tarragon, anise, celery, lemon, lime, lemon grass, marjoram, fennel, dill, nutmeg, parsley, cardamom, chili powder (typically a mixture of chili peppers, onion, paprika, garlic, cumin, and oregano), and ginger. Extracts or essential oils from these spices/flavorings can also be used in the compositions described herein. Illustratively, such extracts or essential oils include but are not limited to allicin, allyl isothiocyanate, cinnamaldehyde, eugenol, thymol, carvacrol, and oleoresin.

Use of the citric acid solution depends upon the particular conditions under which the meat product is being treated, e.g., the humidity level, ambient temperature, the temperature of the carcass, etc. The solution is typically sprayed, brushed, poured, or rubbed directly onto the surface of the meat.

Bacteria, protozoa, microorganisms, maggots, mold, and mildew continuously threaten the edible quality of game meat after harvest. These organisms require a pH range of about 6.0 to 8.0 to survive (though some can survive at a pH as low as 4.2). As blood has a neutral pH of about 7 to 7.5, these organisms can readily thrive on freshly harvested game meat.

Tablet and capsule embodiments herein are formulated to dissolve in the predetermined volume of water but may require the user to shake, stir or otherwise disturb the tablets or capsules to encourage dissolution into the water.

### Flies

The blowfly is one of the first threats to freshly harvested meat as it quickly locates the kill site and begins to deposit eggs onto exposed meat surfaces. Within 24 to 48 hours those eggs transform into maggot larvae. Both flies and maggots are sensitive to acidic pH levels. Maggot larvae require a pH higher than 6 to survive while the adult blowflies prefer to land on surfaces having a pH of about 6.5 to 8. Higher pH levels allow for bacterial growth and decomposing flesh, both of which the maggots thrive on. As such, the more acidic (lower pH) the meat surface, the better the prevention of fly and maggot infestation.

### Giardiasis

The microorganism giardia is an amoeba that, when ingested, causes severe gastrointestinal irritation in humans. It is commonly found in running water, deposited there by infected animals such as beaver, wolves, or moose when the animal deposits an infected stool into the water.

If game meat comes in contact with giardia-infected water, then an individual consuming the meat has a chance of being infected. Like other microorganisms, giardia requires a certain pH to survive; it is believed that giardia cannot survive on surfaces with a pH of 5 or lower.

### Bacteria

Bacteria and other microorganisms thrive on exposed game meat and can cause spoilage of the entire portion of meat. pH levels determine to what extent bacteria and microorganisms can survive. Decomposition of animal tissue occurs at a pH between 6.5 and 8, but the rate of decomposition slows below a pH of about 6.0. However, other factors such as moisture and heat contribute to the optimal environment for microbial growth.

### Moisture

Increased moisture levels provide for an increase in the rate of bacterial growth. Water provides a perfect (neutral pH) environment for growing and spreading bacteria. While it is difficult to calculate the level of moisture on the surface of game meat, it is known that levels below 15% slow the rate of bacterial growth. As such, one goal is to reduce the amount of moisture in and around game meat. In a drier environment, citric acid is more effective in the prevention of bacterial growth.

### Temperature

Mesophilic microorganisms thrive in temperatures ranging from 50° to 105° F. while thermophilic microorganisms prefer temperatures greater than 105° F. Higher meat temperatures (as well as the amount of time the meat remains at the higher temperature) contribute to the rate and level of bacterial growth.

The length of time that passes from when the animal is taken to the time the meat is quartered and cooled is important. In some situations the game animal cannot be found for several hours, allowing for microbial contamination of the carcass. At higher temperatures, thermophilic microorganisms are more aggressive than mesophilic microorganisms, particularly because meat left on the carcass remains at temperatures exceeding 105° F. due the natural post mortem process which generates cellular heat. Therefore, the longer meat remains on the carcass the greater the rate and level of bacterial growth and spoilage.

### Applications

In some embodiments, the citric acid solution is applied immediately upon exposure of game meat to the outside environment. In other embodiments, the citric acid solution is applied within minutes to hours after exposure of game meat to the outside environment. It is desirable, however, to apply the citric acid solution as soon as possible.

The citric acid solution can be applied throughout the process of field dressing the carcass, for example, applied while making the initial cuts in the butchering process, and while skinning back the hide and exposing the meat. All surfaces of the meat, organs, and hide can be contacted with the citric acid solution. The citric acid solution can also be applied to the carcass during the aging process.

In some embodiments, the citric acid solution is applied at various intervals after harvest. How often to reapply citric acid depends on several factors including humidity and the pH of the citric acid solution being used. The citric acid solution can be applied every 4 to 48 hours, for example, about 4 hours, every 6 hours, every 12 hours, every 18 hours, every 24 hours, every 36 hours, every 48 hours, or as needed to prevent or diminish the risk of contamination or spoilage. The higher the humidity, the more often the meat should be treated. Likewise, if the game meat gets wet, it should be treated again. A citric acid solution having a higher pH should be applied more often than a citric acid solution having a lower pH.

Provided herein are methods for prohibiting or mitigating spoilage of meat and/or contamination of meat. In some embodiments, the method comprises preparing a citric acid solution using the formulations described above and applying the solution to meat. In some aspects, spoilage is caused by microbial contamination. In other aspects, spoilage is caused by insects. In still other aspects, spoilage is caused by both microbial contamination and insects.

Also provided are methods for retarding microbial growth. In some aspects, the microbial growth is responsible for spoilage, e.g. mold or yeast. In some aspects, the microbial growth is harmful, e.g. E. coli, listeria, Salmonella, etc.

Provided herein are methods for tenderizing meat. In some embodiments, the method comprises preparing a citric acid solution using the formulations described above and applying the solution to meat. The citric acid breaks down the meat proteins.

Provided herein are methods for preserving hides and for maintaining the hair on a hide or cape. In some embodiments, the method comprises preparing a citric acid solution using the formulations described above and applying the solution to the hide or cape. Illustratively, when the hide or cape is first removed from the animal, the citric acid solution can be applied to the inside (flesh side) of the hide. The citric acid solution can retard bacterial growth on the hide and help mitigate or even prevent hair slippage.

### Kits

Also provided are kits for use with the formulations and methods described herein. In some embodiments, the kit comprises one or more citric acid tablets or capsules and instructions for using the tablets or capsules. In some embodiments, the kit comprises one or more citric acid tablets or capsules and a bottle for mixing the citric acid formulation with water and applying the solution. In some embodiments, the kit comprises one or more citric acid tablets or capsules, a bottle, and instructions for using the tablets or capsules. In some embodiments, the kit comprises a bottle of water with one or more citric acid tablets or capsules in the kit for easy addition to the bottle of water. In some embodiments, the one or more citric acid tablets or capsules is provided in the otherwise empty bottle.

It is contemplated that the tablets or capsules can be combined with water to form a citric acid solution in the same container from which the citric acid solution is applied to the game meat. Exemplary containers include bottles, buckets, bowls, etc. In some embodiments, the bottle is a squirt bottle. In some embodiments, the bottle is a spray bottle. In some aspects, the bottle is a collapsible bottle or a flexible bottle. Illustrative bottles include those made by VapurTM and those made by Platypus™, bottles which may or may not need to be modified with spray nozzles. In other aspects, the bottle is a regular water bottle. The bottle can be standard sized, for example, 8, 12, or 24 ounce bottles, or can be custom sized for the amount of citric acid and water to be used.

Kits can further include filters for removing debris and/or contamination from water obtained remotely, for example, water obtained from puddles, creeks, rivers, ponds, lakes, dirt tanks, livestock tanks, and/or irrigation canals.

Kits can further include spices and/or seasonings for use on the meat.

As used herein, the term “about” or the term “approximately” when used in conjunction with a number refers to any number within 1%, 5%, or 10% of the referenced number.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

### EXAMPLES

The following examples are provided for illustrative purposes only and are not limiting to this disclosure in any way.

### Example 1

Veggie capsules with the following formulation were generated having a 2-3 minute dissolution rate. When two capsules were added to about 16 ounces of water, the resulting solution had a pH of about 2; when 3 capsules were added to about 16 ounces of water, the resulting solution had a pH of about 1.9; when 4 capsules were added to about 16 ounces of water, the resulting solution had a pH of about 1.78.
1,500 mg citric acid
400 mg SAS
100 mg tartaric acid
100 mg malic acid
40 mg sodium bicarbonate and sodium carbonate
20 mg magnesium stearate

In this experiment, it was determined that excipients useful in making tablets are alkaline in nature and thus increase the pH of the resulting formulation. Other formulations generated sediment which clogged the sprayer and still other formulations were too sticky or too compacted or would not dissolve. As such, this formulation used veggie capsules that rapidly dissolved and protected the user from coming into contact with the acid powders.

When introducing elements or features of embodiments herein, the articles “a”, “an”, “the” and “said” are intended to mean that there are one or more of such elements or features. The terms “comprising”, “including”, and “having” are intended to be inclusive and mean that there may be additional elements or features other than those specifically noted. The phrase “consisting essentially of” limits the claimed subject matter to the specified materials or steps “and those that do not materially affect the basic and novel characteristic(s)” of the claimed invention. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A formulation comprising citric acid and one or more of sodium acid sulfate, tartaric acid, malic acid, bicarbonate, and magnesium stearate.

2. The formulation of claim 1, wherein the formulation comprises citric acid, sodium acid sulfate, tartaric acid, malic acid, bicarbonate, and magnesium stearate.

3. The formulation of claim 1, wherein the pH of the formulation when dissolved in water is less than about 3.

4. The composition of claim 1, wherein the pH of the composition when dissolved in water is less than about 2.

5. The formulation of claim 1, wherein the formulation is a capsule.

6. The formulation of claim 1, wherein the formulation is a tablet.

7. The formulation of claim 3, adapted for application to the meat by pouring.

8. The formulation of claim 3, adapted for application to the meat by spraying.

9. A game meat product comprising game meat having a coating applied to the surface, wherein the coating comprises:
i) citric acid; and
ii) one or more of sodium acid sulfate, tartaric acid, malic acid, carbonate, and magnesium stearate.

10. A method of preserving game meat, the method comprising contacting the surface of the game meat with a formulation comprising citric acid and one or more of sodium acid sulfate, tartaric acid, malic acid, carbonate, and magnesium stearate.

11. The method of claim 10, wherein the formulation comprises citric acid, sodium acid sulfate, tartaric acid, malic acid, carbonate, and magnesium stearate.

12. The method of claim 10, wherein the formulation is mixed with water.

13. The method of claim 10, wherein the formulation is mixed with water and sprayed on the surface of the game meat.

14. The method of claim 10, wherein the formulation comprises a tablet.

15. The method of claim 10, wherein the formulation comprises a capsule.

16. A kit comprising:
(i) one or more capsules for preparing a citric acid solution, wherein the one or more capsules comprise citric acid, sodium acid sulfate, tartaric acid, malic acid, carbonate, and magnesium stearate; and
(ii) instructions for using the citric acid solution.

17. The kit of claim 16 further comprising a collapsible bottle configured with a spray top.

18. The kit of claim 16 further comprising additives selected from the group consisting of pepper, cinnamon, cayenne pepper and other hot peppers, curry, oregano, paprika, turmeric, mace, cloves, mint, basil, mustard, allspice, bay leaf, caraway, coriander, cumin, rosemary, sage, thyme, garlic, onion, tarragon, anise, celery, lemon, lime, lemon grass, marjoram, fennel, dill, nutmeg, parsley, cardamom, chili powder, ginger, allicin, allyl isothiocyanate, cinnamaldehyde, eugenol, thymol, carvacrol, and oleoresin.

19. The kit of claim 18, wherein the additives are formulated in the one or more capsules.

20. The kit of claim 18, wherein the additives are formulated separately from the one or more capsules.

21. A method of preserving a game hide, the method comprising contacting the inside surface of the hide with a formulation comprising citric acid and one or more of sodium acid sulfate, tartaric acid, malic acid, carbonate, and magnesium stearate.
